(19) United States
(12) Patent Application Publication
(10) Pub. No.: US 2024/0053428 A1
(43) Pub. Date: Feb. 15, 2024

(54) UWB LOCALIZATION WITH INDEPENDENT UWB ANCHOR SYNCHRONIZATION

(71) Applicants: TRUMPF Tracking Technologies GmbH, Ditzingen (DE); Zigpos GmbH, Dresden (DE)

(72) Inventors: Eberhard Wahl, Weilheim an der Teck (DE); Erik Mademann, Dresden (DE); Christoph Goetze, Dresden (DE)

(21) Appl. No.: 18/495,967

(22) Filed: Oct. 27, 2023

Related U.S. Application Data
(63) Continuation of application No. PCT/EP2022/061140, filed on Apr. 27, 2022.

(30) Foreign Application Priority Data
Apr. 30, 2021 (DE) 10 2021 204 374.7

(51) Int. Cl. G01S 5/02; G01S 13/02

(52) U.S. Cl. CPC G01S 5/02216; G01S 13/0209

(57) ABSTRACT

A method for locating an ultra wideband technology (UWB) mobile unit includes locating a position of the UWB mobile unit using a plurality of UWB anchors. Each UWB anchor includes a first UWB anchor antenna and a second UWB anchor antenna. Communication for positioning measurement purposes from the UWB mobile unit to the plurality of UWB anchors is performed in a first frequency band via the first UWB anchor antennas. Time synchronization of the plurality of UWB anchors is performed in a second frequency band via the second UWB anchor antennas.

### CROSS REFERENCE TO RELATED APPLICATIONS

This application is a continuation of International Application No. PCT/EP2022/061140 (WO 2022/229240 A1), filed on Apr. 27, 2022, and claims benefit to German Patent Application No. 10 2021 204 374.7, filed on Apr. 30, 2021. The aforementioned applications are hereby incorporated by reference herein

### FIELD

Embodiments of the present invention relate to a method for locating a UWB mobile unit, and a device for locating a UWB mobile unit.

### BACKGROUND

It is known practice to locate UWB mobile units. However, the number of UWB mobile units that can be located and the update rate of the UWB mobile units that can be located are limited.

### SUMMARY

Embodiments of the present invention provide a method for locating an ultra wideband technology (UWB) mobile unit. The method includes locating a position of the UWB mobile unit using a plurality of UWB anchors. Each UWB anchor includes a first UWB anchor antenna and a second UWB anchor antenna. Communication for positioning measurement purposes from the UWB mobile unit to the plurality of UWB anchors is performed in a first frequency band via the first UWB anchor antennas. Time synchronization of the plurality of UWB anchors is performed in a second frequency band via the second UWB anchor antennas.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a localization system for locating a UWB mobile unit using various UWB anchor antennas;

FIG. 2 schematically shows the signals sent using the various UWB anchor antennas; and

FIG. 3 schematically shows standardized frequency ranges for compiling the signals sent in FIG. 2.

### DETAILED DESCRIPTION

Embodiments of the present invention provide a method and a device that can increase the possible number of UWB mobile units that can be located and the update rate of the UWB mobile units that can be located.

Embodiments of the invention provide a method for locating at least one UWB mobile unit (“tag” or “tag device”) using multiple UWB anchors (“beacons”). The UWB anchors each comprise a first UWB anchor antenna and a second UWB anchor antenna. The communication from the UWB mobile unit to the UWB anchors for positioning measurement purposes takes place in a first frequency band by way of the first UWB anchor antennas. By contrast, the exact time synchronization of the UWB anchors takes place in a second frequency band by way of the second UWB anchor antennas.

The exact time synchronization of the UWB anchors requires synchronization data packets to be frequently (approximately every 100 ms) interchanged between the UWB anchors. As a result of the communication of the UWB anchors with the at least one UWB mobile unit being decoupled from the communication of the UWB anchors with each other it is possible for the method to be carried out very precisely, reliably and in crash-resistant fashion.

UWB is a radio standard that is used over short distances and for localization purposes in factories (industrial manufacturing facilities). Ultra-wideband is robust toward interference from other radio sources and multiple reflections, which can frequently occur in particular in factories in the metal processing industry, and ensures precise localization of materials, orders and navigation of automated guided vehicles (AGVs) and drones—even when there are obstacles such as metal reflections.

Construction, localization, communication and/or data protocols using UWB can take place in particular in accordance with the description of WO 2020/212722 A1, which is included in this application in its entirety by way of reference. WO 2020/212722 A1, entitled “Ultra-Wideband Location Systems and Methods”, was filed on Apr. 19, 2019 and published on Oct. 22, 2020.

Preferably, UWB components that comply with the IEEE 802.15.4z and/or IEEE802.15.4ab standard are used for the UWB anchor(s) and/or the localization system.

Radio communication between the mobile units and the UWB anchors can be transmitted using available UWB, Bluetooth Low Energy (BLE) and/or ZigBee. ZigBee is a specification for wireless networks with low data volume and low power consumption such as home automation, sensor networks and lighting. ZigBee is based on the IEEE 802.15.4 standard and extends the functionality thereof in particular by the possibility of routing and secure key exchange.

The UWB anchors are preferably at a minimum distance of 5 m, in particular 10 m, preferably 20 m, from one another.

The first UWB anchor antennas and the second UWB anchor antennas can each be controlled jointly by a microcontroller and/or a System on Chip (SOC). Alternatively, the first UWB anchor antennas can each be controlled by a first microcontroller and/or by a first SOC and the second UWB anchor antennas can each be controlled by a second microcontroller and/or by a second SOC.

The position of the UWB mobile unit can be determined by a time difference of arrival (TDoA) method. This involves the UWB mobile unit sending UWB signals that are received by the UWB anchors. The UWB anchors, whose location information is known and whose system time is synchronized, compare the time of arrival of these UWB signals. The position of the UWB mobile unit is then calculated from the time difference of arrival.

The position of the UWB mobile unit can be determined using the standard of the Car Connectivity Consortium (CCC, see https://carconnectivity.org/) and/or the Fine Ranging (fira, see https://www.firaconsortium.org/) Consortium. The communication in the standard of the CCC and/or of the fira Consortium preferably takes place in a frequency band around 8 GHz. This allows a UWB mobile unit in the form of a consumer device, in particular in the form of a smartphone and/or handheld device, to be detected.

In an embodiment of the invention, the synchronization of the UWB anchors takes place in a frequency band around 4 GHz.

Alternatively or in addition, the synchronization of the UWB anchors can take place using an industrial standard, in particular using the Omlox standard.

Omlox is an open standard for a precise real-time localization system for indoor spaces. Omlox defines open interfaces for an interoperable localization system. Omlox allows different tag manufacturers to use the same infrastructure with different applications from different providers. Since the same infrastructure is used, the overall operating costs are lowered, which allows simple integration of different applications. A key feature of omlox is that it enables a cyberphysical simplification and combines the integration of industrial software and hardware solutions into a shared ecosystem.

Using omlox-based UWB anchors, various types of software such as a manufacturing executive system (MES), asset tracking and navigation with anti-collision, and also hardware such as drones, AGVs and loading vehicles, can be integrated into the localization area.

Omlox enables interoperability and flexibility for different trackable providers within one or more tracking zones. Omlox achieves this through two core components: Omlox Hub and Omlox Core Zone. The Omlox Hub enables interoperability and flexibility within different tracking zones, while the Omlox Core Zone provides interoperability and flexibility within a single tracking zone.

The Omlox Hub enables interoperability and flexibility across different complementary zones. In addition to UWB, other localization technologies such as RFID, 5G, BLE, WIFI and GPS are also used in production, delivery and storage. Omlox can be used to ensure that networks function smoothly and interoperably. Businesses are thereby easily able to network applications such as production control systems, installation tracking and navigation across different location zones.

The Omlox Hub is compatible with multiple tracking zones. Smart factories that operate with a UWB localization zone, a truck loading area with GPS positioning and a warehouse with WIFI positioning can be efficiently monitored using the Omlox Hub. The Omlox Hub enables the transmission, synchronization and alignment of maps from discrete local coordinates (mapping of SLAM and other techniques) to global geographical coordinates of a smart factory, i.e. a production environment in which manufacturing plants and logistics systems largely organize themselves, with little or no human intervention, in order to produce the desired products. SLAM means: Simultaneous Localization and Mapping.

The Omlox Core Zone includes an open radio interface and guarantees interoperability in the UWB range. Omlox creates an interoperable infrastructure that operates by plug-and-play. Using the Omlox standard, businesses are able to network all UWB products quickly and easily independently of the manufacturer.

The UWB communication takes place within the Omlox Core Zone. The Omlox Hub is one level above that.

The characteristics of the Omlox anchors are described in more detail in the Omlox specification, which is published on https://omlox.com.

In an embodiment of the invention, the synchronization of the UWB anchors is used by the UWB mobile unit in order to achieve self-localization of the UWB mobile unit. There can be provision for this self-localization in the Omlox standard. In this GPS-like mode, “the UWB mobile unit only listens to UWB” and then calculates its own position itself.

The UWB anchors can perform wired and/or wireless data transfer to a computing unit. The UWB anchors can transmit data regarding the position of the UWB mobile unit to the computing unit. In addition, the UWB anchors can transmit data regarding at least one signal parameter, for example the signal strength of UWB signals of the UWB mobile unit, to the computing unit. The computing unit can comprise an algorithm for locating the UWB mobile unit based on the data from the UWB anchors.

The data transfer between the UWB anchors, for exact time synchronization, can preferably take place by way of the second UWB anchor antennas. Since the second UWB anchor antennas are not used to communicate with the UWB mobile unit, there is no bandwidth conflict here.

The radiation by way of the first UWB anchor antennas can take place conically. Alternatively or in addition, the radiation by way of the second UWB anchor antennas can take place circularly. The beam angles of the first UWB anchor antennas are preferably conically downward to facilitate optimum contact with the UWB mobile unit. The beam angles of the second UWB anchor antennas are preferably circular in the horizontal to facilitate optimum contact between the UWB anchors.

The method according to embodiments of the invention can be used to locate at least 5 UWB mobile units. As a result of the data interchange between the UWB anchors being decoupled from the data interchange between the UWB mobile units and the UWB anchors, reliable localization of a multiplicity of UWB mobile units is facilitated. The method is preferably used to locate at least 100, in particular at least 200, preferably at least 500, UWB mobile units.

Embodiments of the invention also provide a device for locating a UWB mobile unit, in particular for carrying out a method described here. The device comprises a UWB mobile unit. The device further comprises multiple UWB anchors, each UWB anchor comprising a first UWB anchor antenna and a second UWB anchor antenna. The first UWB anchor antennas are designed to receive UWB signals of the UWB mobile unit in a first frequency band. The second UWB anchor antennas are designed to send and receive UWB signals between the UWB anchors for the purpose of exact time synchronization of the UWB anchors in a second frequency band.

The device preferably comprises a computing unit connected wirelessly and/or by wire to the UWB anchors for the purpose of determining the position of the UWB mobile unit.

The UWB anchors are preferably designed to communicate with the computing unit by way of the second UWB anchor antennas.

The device can comprise a central software module for setting up and managing the UWB anchors. The software module can be stored in the computing unit. Alternatively, the software module can be stored in a cloud of the device. System maintenance and system update can thus be performed from an instance that is remote from the UWB anchors.

The UWB anchors of the device can have one or more of the following features:
a) a common housing for the first UWB anchor antenna and the second UWB anchor antenna;
b) a common printed circuit board connected to both the first UWB anchor antenna and the second UWB anchor antenna;
c) a first microcontroller for controlling the first UWB anchor antenna and a second microcontroller for controlling the second UWB anchor antenna; and/or
d) a first system on chip (SOC) for controlling the first UWB anchor antenna and a second SOC for controlling the second UWB anchor antenna.

In an embodiment of the invention, at least one UWB anchor is integrated in a smoke detector and/or in a light of the device.

Further advantages of the invention are evident from the description and the drawing. Similarly, according to embodiments of the invention, the features mentioned above and those yet to be explained further can be used in each case individually or together in any desired combinations. The embodiments shown and described should not be understood as an exhaustive list, but rather are of an illustrative character to outline the invention.

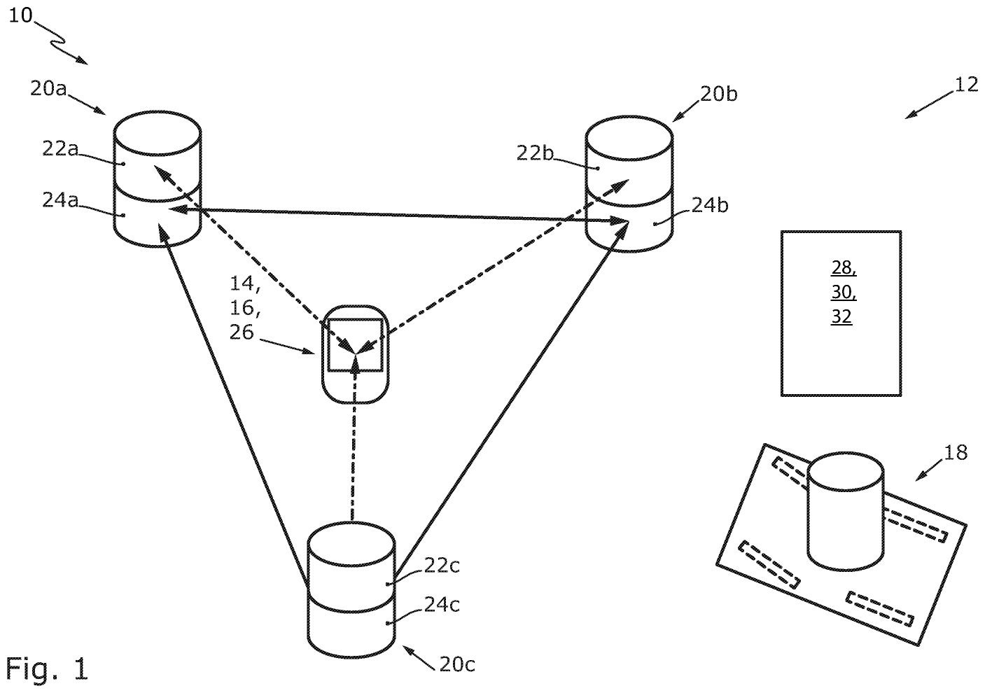

FIG. 1 shows an interior, in particular an industrial manufacturing facility 10, with a device 12 for locating a UWB mobile unit 14. The UWB mobile unit 14 can be part of a consumer device 16, here in the form of a smartphone. The UWB mobile unit 14 can alternatively be arranged on a self-driving vehicle 18 (AGV) or formed on the self-driving vehicle 18. The self-driving vehicle 18 is used for transporting materials in the interior, in particular the industrial manufacturing facility 10. For reasons of clarity, this variant is not detailed further in FIG. 1.

The device 12 comprises UWB anchors 20a, 20b, 20c for locating the UWB mobile unit 14. The UWB anchors 20a-c each have a first UWB anchor antenna 22a, 22b, 22c and a second UWB anchor antenna 24a, 24b, 24c. The first UWB anchor antennas 22a-c are used for communication (shown using dash-dot arrows) with a UWB mobile unit antenna 26, the second UWB anchor antennas 24a-c are used for exact time synchronization (shown using solid arrows) of the UWB anchors 20a-c with one another. The UWB anchors 20a-c are connected wirelessly or by wire to a computing unit 28 (not shown for reasons of clarity). The connection is preferably made by way of the second UWB anchor antennas 24a-c.

The computing unit 28 ascertains the position of the UWB mobile unit 14 by way of the first UWB anchor antennas 22a-c and the UWB mobile unit antenna 26. The position can be determined using an algorithm 30, in particular on a computer 32.

According to embodiments of the invention, there is provision for the determination of the position of the UWB mobile unit 14 to be separated from the exact time synchronization of the UWB anchors 20a-c. This allows the position determination to take place in more reliable and stable fashion, even with a multiplicity of UWB mobile units 14.

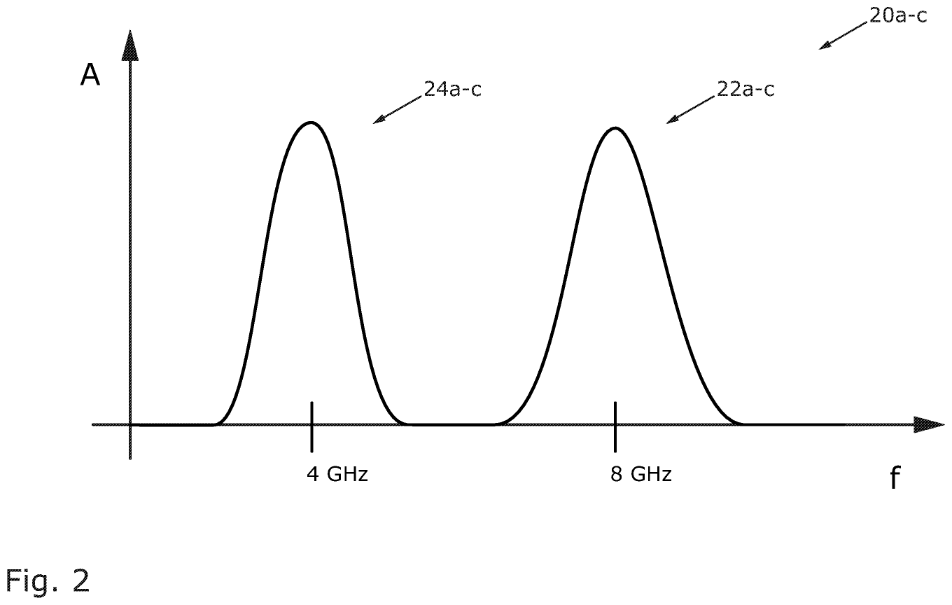

FIG. 2 shows that the signal transfer from and to the UWB anchors 20a-c preferably takes place at frequencies around 4 GHz and 8 MHz. More specifically, the first UWB anchor antennas 22a-c preferably send and receive at frequencies around 8 GHz and the second UWB anchor antennas 24a-c at frequencies around 4 GHz. The bandwidths shown in FIG. 2 are purely illustrative. Bandwidths can typically be 500 MHz.

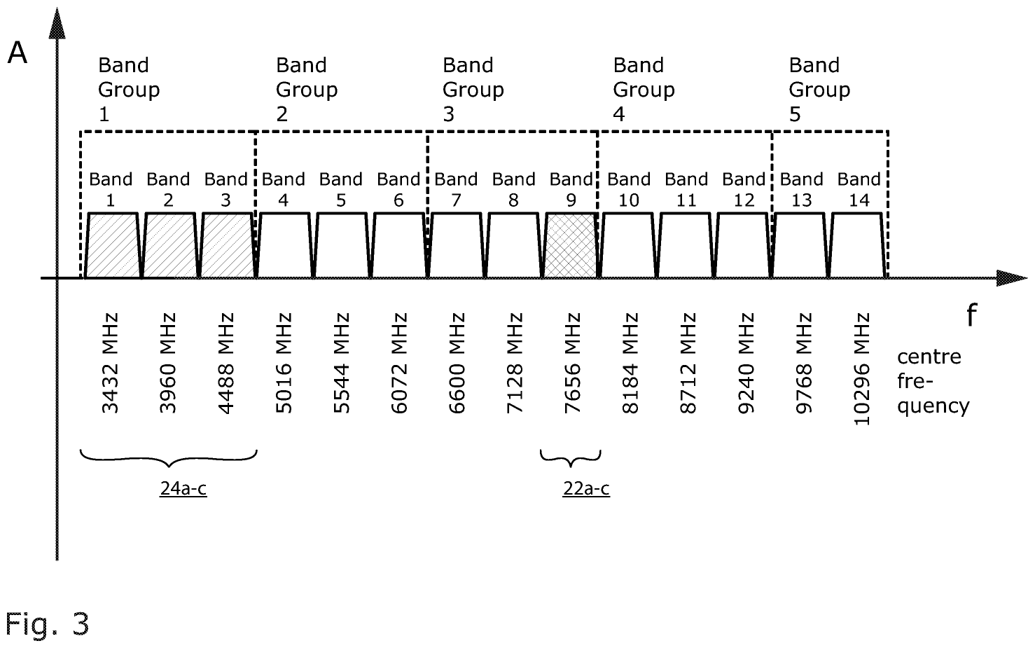

FIG. 3 shows the frequencies preferably used by the first UWB anchor antennas 22a-c and the second UWB anchor antennas 24a-c. It can be seen from FIG. 3 that the first UWB anchor antennas 22a-c preferably use frequency band 9 with the center frequency 7656 MHz, and the frequency bands 1, 2 and 3 with the center frequencies 3432 MHz, 3960 MHz and 4488 MHz are preferably used for the second UWB anchor antennas 24a-c.

Therefore, embodiments of the invention relate to a method and a device 12 for locating at least one UWB mobile unit 14, in particular for locating a multiplicity of UWB mobile units 14. The locating takes place as a result of first UWB anchor antennas 22a-c communicating with the mobile unit(s) 14. Second UWB anchor antennas 24a-c are used for exact time synchronization of the UWB anchors 20a-c with one another. The second UWB anchor antennas 24a-c are preferably also used to allow the UWB anchors 20a-c to communicate with a computing unit 28.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 industrial manufacturing facility
12 device
14 UWB mobile unit
16 consumer device
18 self-driving vehicle
20a-c UWB anchor
22a-c first UWB anchor antenna
24a-c second UWB anchor antenna
26 UWB mobile unit antenna
28 computing unit
30 algorithm
32 computer

1. A method for locating an ultra wideband technology (UWB) mobile unit, the method comprising:
locating a position of the UWB mobile unit using a plurality of UWB anchors, each UWB anchor comprising a first UWB anchor antenna and a second UWB anchor antenna, wherein:
communication for positioning measurement purposes from the UWB mobile unit to the plurality of UWB anchors is performed in a first frequency band via the first UWB anchor antennas; and
time synchronization of the plurality of UWB anchors is performed in a second frequency band via the second UWB anchor antennas.

2. The method as claimed in claim 1, wherein:
each of the first UWB anchor antennas is controlled by a first microcontroller and/or by a first system on chip (SOC); and
each of the second UWB anchor antennas is controlled by a second microcontroller and/or a second SOC.

3. The method as claimed in claim 1, wherein the position of the UWB mobile unit is determined by a time difference of arrival method.

4. The method as claimed in claim 3, wherein the position of the UWB mobile unit is determined using a standard of Car Connectivity Consortium (CCC) and/or Fine Ranging (fira) Consortium.

5. The method as claimed in claim 1, wherein the second frequency band is around 4 GHz.

6. The method as claimed in claim 1, wherein the synchronization of the UWB anchors is performed using Omlox standard.

7. The method as claimed in claim 1, wherein the synchronization of the UWB anchors is used by the UWB mobile unit to locate itself.

8. The method as claimed in claim 1, wherein a wired and/or wireless data transfer from the plurality of UWB anchors to a computing unit is performed.

9. The method as claimed in claim 8, wherein the data transfer from the plurality of UWB anchors to the computing unit is performed via the second UWB anchor antennas.

10. The method as claimed in claim 1, wherein:
radiation by the first UWB anchor antennas takes place conically; and/or
radiation by the second UWB anchor antennas takes place circularly.

11. A device for locating an ultra wideband technology (UWB) mobile unit, for carrying out the method as claimed in claim 1, the device comprising:
a UWB mobile unit;
a plurality of UWB anchors, each UWB anchor comprising a first UWB anchor antenna and a second UWB anchor antenna, the first UWB anchor antennas being configured to receive UWB signals of the UWB mobile unit in a first frequency band, and the second UWB anchor antennas being configured to send and receive UWB signals between the UWB anchors for synchronization of the UWB anchors in a second frequency band.

12. The device as claimed in claim 11, further comprising:
a computing unit connected to the plurality of UWB anchors wirelessly and/or by wire for determining the position of the UWB mobile unit.

13. The device as claimed in claim 12, wherein the plurality of UWB anchors are configured to communicate with the computing unit via the second UWB anchor antennas.

14. The device as claimed in claim 11, wherein each of the plurality of UWB anchors comprises at least one of:
a common housing for the first UWB anchor antenna and the second UWB anchor antenna;
a common printed circuit board connected to both the first UWB anchor antenna and the second UWB anchor antenna;
a first microcontroller for controlling the first UWB anchor antenna and a second microcontroller for controlling the second UWB anchor antenna; or
a first system on chip (SOC) for controlling the first UWB anchor antenna and a second SOC for controlling the second UWB anchor antenna.

15. The device as claimed in claim 10, wherein at least one UWB anchor is integrated in a smoke detector and/or in a light of the device.
